(19) United States
(12) Patent Application Publication
(10) Pub. No.: US 2019/0318596 A1
(43) Pub. Date: Oct. 17, 2019

(54) System And Method For Identifying And Mitigating A Threat In A Facility

(71) Applicant: Mahindra N.A. Tech Center, Auburn Hills, MI (US)

(72) Inventor: John P. PACELLA, Rochester Hills, MI (US)

(21) Appl. No.: 15/953,705

(22) Filed: Apr. 16, 2018

(51) Int. Cl. G08B 17/08; H04N 7/18; G10L 15/22; G05D 1/00; G05D 1/12; G05D 1/10; B64C 39/02; B64C 37/00; F41G 3/22

(52) U.S. Cl. CPC G08B 17/08; H04N 7/185; G10L 15/22; G05D 1/0027; G05D 1/12; F41G 9/002; G05D 1/0094; B64C 39/024; B64C 37/00; F41G 3/22; G10L 2015/223; G05D 1/104

(57) ABSTRACT

A system for mitigating a threat in a facility according to the present disclosure includes a threat identification module and at least one group of drones. The threat identification module is configured to generate a threat identification signal indicating that the threat has been identified in the facility and transmit the threat identification signal to a central command center. The at least one group of drones is configured to move toward the threat in response to at least one of the threat identification signal and a command from the central command center.

### FIELD

The present disclosure relates to systems and methods for identifying and mitigating a threat in a facility.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In recent years, there have been a number of threats, such as a person holding and/or discharging a weapon, in facilities such as schools, government buildings, and businesses. Typically, these threats are identified by individuals in the facility where the threats take place, and those individuals notify a police dispatch of the threat by making a phone call or triggering an alarm. In turn, the police dispatch sends police officers and other emergency response personnel to the facility, and the police officers mitigate the threat by, for example, arresting a person discharging a weapon in the facility.

The process described above requires individuals in the facility to risk their lives by making a phone call or triggering an alarm. In addition, the above process requires police officers to risk their lives by entering the facility to mitigate the threat. Further, the response time of the threat mitigation may be increased due to the time it takes for the police dispatch to gather information during the phone call and relay that information to the police officers, as well as the time it takes for the police officers to travel to the facility. Moreover, in many cases, the police officers do not know the location of the threat within the facility, which may further increase the threat mitigation response time.

### SUMMARY

A system for mitigating a threat in a facility according to the present disclosure includes a threat identification module and at least one group of drones. The threat identification module is configured to generate a threat identification signal indicating that the threat has been identified in the facility and transmit the threat identification signal to a central command center. The at least one group of drones is configured to move toward the threat in response to at least one of the threat identification signal and a command from the central command center.

In one example, the system further includes a gunshot detection module configured to detect a gunshot in the facility, and the threat identification module is configured to generate the threat identification signal when the gunshot is detected.

In one example, the threat identification module is configured to generate the threat identification signal when a silent alarm is triggered in the facility.

In one example, the threat identification module is configured to generate the threat identification signal when an emergency call is made from the facility.

In one example, the system further includes a microphone located in the facility, and the threat identification module is configured to generate the threat identification signal when the microphone detects a predetermined voice command.

In one example, the system further includes a weapon detection module configured to detect a weapon in the facility, and the threat identification module is configured to generate the threat identification signal when the weapon is detected.

In one example, the threat identification signal further indicates a location of the threat, and the at least one group of drones is configured to fly toward the threat in response to the threat identification signal.

In one example, each of the at least one group of drones includes at least three drones.

In one example, each of the at least one group of drones includes a leader drone and a follower drone. The leader drone includes a leader drone control module configured to control the leader drone to move toward the threat in response to at least one of the threat identification signal and the command from the central command center. The follower drone includes a follower drone control module configured to control the follower drone to follow the leader drone.

In one example, the at least one group of drones includes a plurality of drone groups, the system further includes a nest for each group of drones and the number and positions of the nests are selected to ensure that at least one of the drones groups arrives at the threat within a desired response time.

In one example, at least one of the drones includes a microphone configured to record audio, a camera configured to record video, and a transmitter configured to transmit the recorded audio and the recorded video to the central command center.

In one example, at least one of the drones includes a weapon, and a drone control module configured to discharge the weapon at the threat.

In one example, at least one of the drones is configured to crawl under a door when the threat is located in a room of the facility that is accessible by the door and the door is closed.

A method for identifying and mitigating a threat in a facility includes generating a threat identification signal indicating that the threat has been identified in the facility, transmitting the threat identification signal to a central command center, and controlling at least one group of drones to move toward the threat in response to the threat identification signal.

In one example, the method further includes detecting a gunshot in the facility, and generating the threat identification signal when the gunshot is detected.

In another example, the method further includes generating the threat identification signal when a silent alarm is triggered in the facility.

In another example, the method further includes generating the threat identification signal when an emergency call is made from the facility.

In another example, the method further includes generating the threat identification signal when a microphone located in the facility detects a predetermined voice command.

In another example, the method further includes detecting a weapon in the facility, and generating the threat identification signal when the weapon is detected.

In another example, the threat identification signal further indicates a location of the threat, and the method further includes controlling the at least one group of drones to fly toward the threat in response to the threat identification signal.

In another example, the method further includes transmitting a command from the central command center to the facility in response to the threat identification signal, and the at least one group of drones is configured to fly toward the threat in response to the command from the central command center.

In another example, each of the at least one group of drones includes a leader drone and a follower drone, and the method further includes controlling the leader drone to move toward the threat in response to the threat identification signal, and controlling the follower drone to follow the leader drone.

In another example, the at least one group of drones includes a plurality of drone groups, and the method further includes selecting the number and positions of the drone groups to ensure that at least one of the drones groups arrives at the threat within a desired response time.

In another example, at least one of the drones includes a microphone configured to record audio and a camera configured to record video, and the method further includes transmitting the recorded audio and the recorded video to the central command center.

In another example, at least one of the drones includes a weapon, and the method further includes discharging the weapon at the threat.

In another example, the method further includes controlling at least one of the drones to crawl under a door when the threat is located in a room of the facility that is accessible by the door and the door is closed.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a network of facilities and a central command center according to the principles of the present disclosure;

FIG. 2 is a functional block diagram of a central command center and a facility including a plurality of drone groups according to the present disclosure;

FIG. 3 is a functional block diagram of a drone group according to the present disclosure; and

FIG. 4 is a flowchart illustrating a method for identifying and mitigating a threat in a facility according to the present disclosure.

In the drawings, reference numbers may be reused to identify similar and/or identical elements.

### DETAILED DESCRIPTION

A system for identifying a threat in a facility according to the present disclosure includes one or more threat detection modules in the facility, one or more groups of drones that are each housed within a drone nest in the facility, and one or more drone control modules. The threat detection modules detect a threat in the facility such as a person holding and/or discharging a weapon. The drone control modules control the drones to move toward the threat and thereby mitigate the threat. For example, if a person is discharging a weapon at the drones instead of other people in the facility, the drones have mitigated the threat. In addition, the drones may be equipped with a weapon, and the drone control modules may control the drones to discharge the weapon at the threat to mitigate the threat.

In one example, the system further includes a threat identification module that identifies a threat in the facility when a weapon is present in the facility, a weapon is discharged in the facility, an emergency call is made from the facility, and/or a silent alarm is triggered in the facility. The threat identification module transmits a signal to a central command center when a threat is identified and, in response to the signal, a drone operator in the central command center controls each drone group to move toward the threat. In addition, a chief (e.g., a police officer) in the central command center coordinates operation of the drone groups and communicates with local authorities.

Operation of the drone groups may be partially or fully automated. In an example of the former, the drone operator in the central command center sets a target location that is at or near the location of the threat, and each drone control module controls a drone group to move to the target location. In an example of the latter, each drone control module sets the target location at or near the location of the threat, controls a drone group to move toward the target location, and performs these tasks independent of the central command center.

Identifying a threat in a facility and using drone groups to mitigate the threat as described above takes more of a proactive approach to threat identification and mitigation than a reactive one. As a result, a system and method according to the present disclosure identifies and mitigates threats faster than conventional approaches, which may save lives. In addition, by using gunshot and/or weapon detectors to identify a threat and using drone groups to mitigate the threat, the system and method reduces the risks taken by individuals in a facility to notify others of a threat and the risks taken by police officers to mitigate a threat.

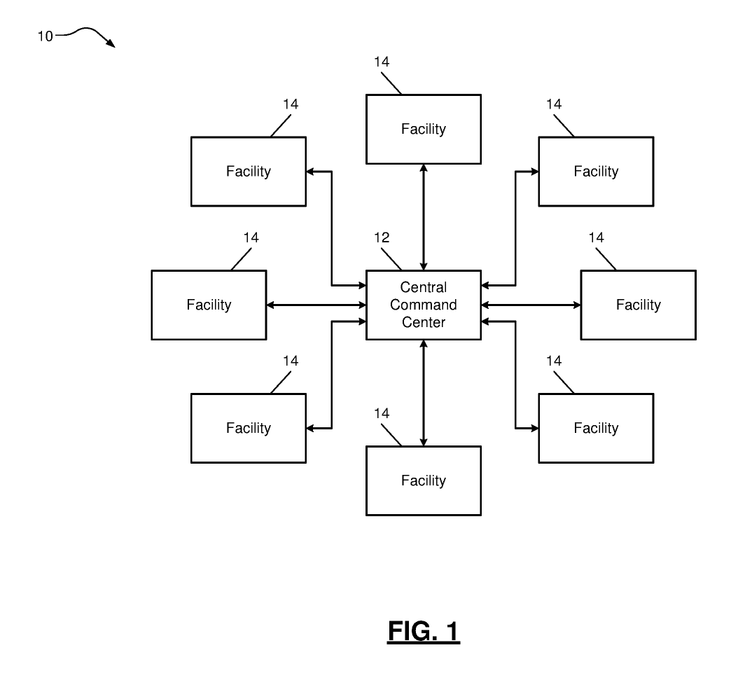

Referring now to FIG. 1, a network 10 according to the present disclosure includes a central command center 12 and a plurality of facilities 14. The central command center 12 communicates with each facility 14 via Wi-Fi, the Internet, and/or a cellular network. The central command center 12 is a building equipped to enable trained personnel to identify and mitigate a threat in any one of the facilities 14 such as a person holding and/or discharging a weapon. The one central command center 12 identifies and mitigates threats in the multiple facilities 14. Each facility 14 is a building where a threat may occur such as a school, a government building, or a business.

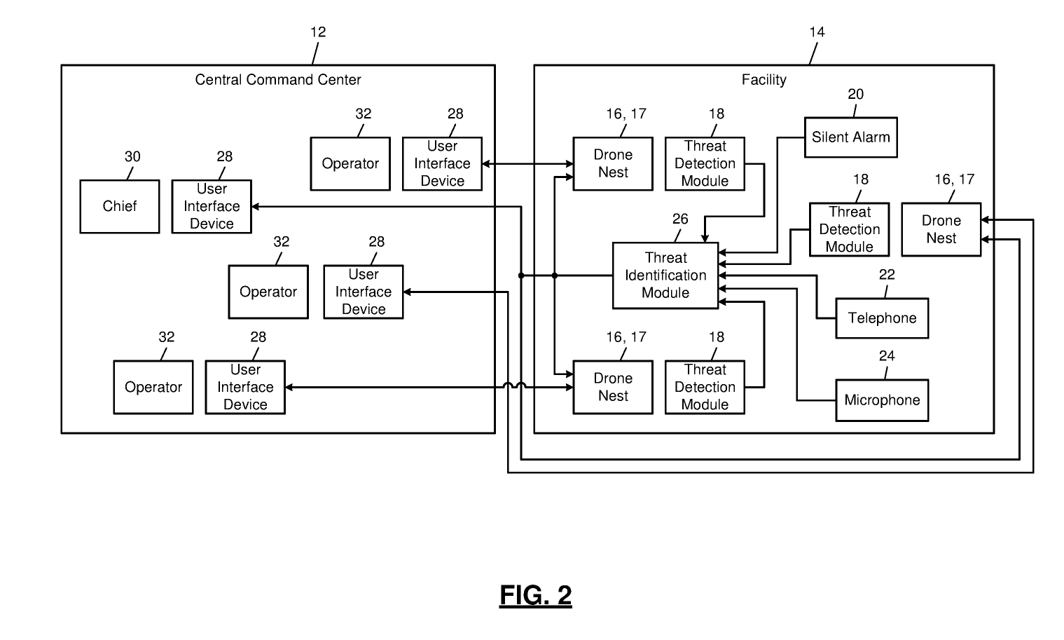

Referring to FIG. 2, example implementations of the central command center 12 and the facilities 14 are shown. While the network 10 of FIG. 1 includes a plurality of the facilities 14, only one of the facilities 14 is shown in FIG. 2 and is referred to herein as the facility 14 for ease of discussion. It should be understood that each of the facilities 14 of FIG. 1 may be similar or identical to the facility 14 of FIG. 2.

The facility 14 includes a plurality of drone pods, clusters, swarms, or groups 16 that are each stationed within a drone nest 17, a plurality of threat detection modules 18, a silent alarm 20, a telephone 22, a microphone 24, and a threat identification module 26. Each drone group 16 may include at least three drones that are configured to move (e.g., fly, crawl) toward a threat in the facility 14. For example, the drones may be equipped with propellers and rudders that enable the drones to fly. In another example, the drones may be with robotic legs that enable the drones to crawl. In addition, the size of the drones may be selected to enable the drones to crawl through small spaces such as a gap between the bottom of a closed door and a floor. For example, each drone may have a height of approximately one-half of an inch.

The mere presence of the drone groups 16 near the threat may mitigate the threat. For example, if the threat is a person discharging a weapon and the person discharges the weapon at the drone groups 16 instead of other people, the drone groups 16 have mitigated the threat. The drone groups 16 may also be configured to mitigate the threat in other ways, such as by discharging a weapon at the threat. The drone groups 16 may also be configured to gather information regarding the threat, such as audio or video within the vicinity of the threat, and to transmit the information to the central command center 12.

Each drone nest 17 is a physical structure that is fixed to the facility 14 and houses a corresponding one of the drone groups 16. The drone nests 17 may hide the drone groups 16 from plain view and/or may include charge stations for charging the drones. In one example, each drone nest 17 completely encloses a corresponding one of the drone groups 16 except for a hidden opening or an opening that is normally closed off by a deployment door except for when the drones are deployed (e.g., outside of nest 17). In another example, each drone nest 17 may include a charge adapter for each drone, a chord and/or plug configured to receive power from a power source (e.g., an outlet) in each facility 14, and a circuit that delivers power from the chord and/or plug to the charge adapters.

The number and positions of the drone nests 17 are selected to ensure that at least one of the drone groups 16 arrives at a threat in the facility 14 within a desired response time. Thus, number and positions of the drone nests 17 may be selected based on the size and accessibility of each facility 14. In addition, each facility 14 may have a unique arrangement (e.g., number, positions) of the drone nests 17.

Each threat detection module 18 detects a threat in the facility 14 and outputs a signal indicating when a threat is detected in the facility 14, the type of threat that is detected, and/or the location of the threat. The threat detection modules 18 are strategically placed in the facility 14 to ensure that any threat that occurs in the facility 14 will be detected by at least one of the threat detection modules 18. For example, the threat detection modules 18 may be placed in hallways, doorways, and/or rooms of the facility 14. In FIG. 2, the number of threat detection modules 18 included in the facility 14 is equal to the number of drone groups 16 and the facility 14, and each threat detection module 18 is co-located with (e.g., located within a predetermined distance of) one of the drone groups 16. However, the number of threat detection modules 18 may be different than the number of drone groups 16, and the threat detection modules 18 may be at different locations than the drone groups 16.

Each threat detection module 18 may include a gunshot detection module that detects when a gunshot occurs in the facility 14. The gunshot detection module may also detect the location of the gunshot and/or the direction of the gunshot. The gunshot detection module may detect when a gunshot occurs in the facility 14, the location of the gunshot, and the direction of the gunshot based on an input from an acoustic sensor in the facility 14 (such as the microphone 24) and/or an optical sensor in the facility 14. The gunshot detection module outputs a signal indicating when a gunshot is detected in the facility 14, the number of gunshots detected, the location of the gunshot(s), and/or the direction of the gunshot(s).

Additionally or alternatively, each threat detection module 18 may include a weapon detection module that detects a weapon in the facility 14. The weapon detection module may emit electromagnetic radiation that makes microwaves (e.g., waves within a frequency range from 500 megahertz to 5 gigahertz). The microwaves are reflected by objects in the facility 14, such as human bodies and/or weapons, and the reflected microwaves are detected by the weapon detection module. The weapon detection module may have a large detection range (e.g., 2 meters), and therefore the weapon detection module may be located in concealed places. The weapon detection module may then differentiate between a normal reflection of the human body and an abnormal reflection of the human body (e.g., a human body carrying a weapon). The weapon detection module makes this differentiation based on the wavelengths and/or frequencies of the reflected microwaves, as well as the shape or pattern of the wavelengths and/or frequencies of the reflected microwaves.

In addition, the weapon detection module may identify the particular type of weapon that is present in the facility 14. To this end, different types of weapons have different shapes. Thus, the weapon detection module may identify the particular type of weapon based on the shape or pattern of the wavelengths and/or frequencies of the reflected microwaves. For example, the weapon detection module may store a plurality of predetermined shapes of reflected wave patterns that each correspond to a type of weapon, and identify that a particular type of weapon is present in the facility 14 when the shape of a reflected wave pattern matches one of the predetermined shapes. The weapon detection module outputs a signal indicating when a weapon is detected in the facility 14, the location of the weapon in the facility 14, and/or the type of the weapon.

In various implementations, the weapon detection module may determine whether a person holding a weapon in the facility 14 is authorized to hold the weapon, and the signal output by the weapon detection module may indicate the outcome of this determination. The weapon detection module may determine whether a person is authorized to hold a weapon based on an image captured by a camera in the facility 14 and/or on one of the drones. For example, the weapon detection module may compare a face of a person in the image to a plurality of predetermined faces of individuals that are authorized to hold a weapon in the facility 14. If the face of the person in the image matches one of the faces of the authorized individuals, the weapon detection module may determine that the person is authorized to hold a weapon in the facility 14. Otherwise, the weapon detection module may determine that the person is not authorized to hold the weapon in the facility 14.

The silent alarm 20 notifies the central command center 12 when a threat is observed and the facility 14 without making a noise. In one example, the silent alarm 20 includes a sensor (e.g., a laser sensor) that detects a trespasser in the facility 14 and outputs a signal indicating when a trespasser is detected. In another example, the silent alarm 20 includes a button or touchscreen that enables a person to notify the central command center 12 when the person observes a threat in the facility 14. The button or touchscreen may output a signal indicating that a threat has been observed in the facility 14 when the button or touchscreen is pressed.

The telephone 22 enables a person in the facility 14 to make an emergency call to notify the central command center 12 and/or emergency personnel (e.g., police) when the person observes a threat in the facility 14. The telephone 22 may be a landline telephone or a cell phone. The telephone 22 outputs a signal indicating audio detected by the telephone 22 such as words spoken into the telephone 22 during an emergency phone call. The microphone 24 detects audio within the facility 14 within the vicinity of the microphone 24. The microphone 24 outputs a signal indicating audio detected by the microphone 24 such as words spoken into the microphone 24.

The threat identification module 26 identifies a threat in the facility 14 based on an input from the threat detection module 18, the silent alarm 20, the telephone 22, and/or the microphone 24. When a threat is identified in the facility 14, the threat identification module 26 generates a threat identification signal indicating that a threat has been identified in the facility 14. The threat identification module 26 transmits the threat identification signal to the central command center 12 and/or the drone groups 16.

The threat identification module 26 may identify a threat in the facility 14 when the threat detection module 18 detects a gunshot and/or a weapon. If the threat detection module 18 determines whether a person holding a weapon in the facility 14 is authorized to do so, the threat identification module 26 may only identify a threat in the facility 14 when the person is not authorized to hold the weapon. The threat identification module 26 may identify a threat in the facility 14 when the silent alarm 20 is triggered. The threat identification module 26 may identify a threat in the facility 14 when an emergency call is made using the telephone 22. The threat identification module 26 may recognize words in the audio signal from the telephone 22 and distinguish between emergency calls and nonemergency calls based on the recognized words. For example, the threat identification module 26 may recognize an emergency call when a recognized word matches a predetermined word or phrase.

Similarly, the threat identification module 26 may recognize words in the audio signal from the microphone 24 and identify a threat in the facility 14 when a recognized word matches a predetermined word or phrase. In various implementations, rather than the threat identification module 26 recognizing words in the audio signal(s) from the telephone 22 and/or the microphone 24, the facility 14 may include a word recognition module (not shown) may perform this word recognition and outputs a word recognition signal indicating the recognized words. The threat identification module 26 may then identify a threat than the facility 14 based on the word recognition signal. The word recognition module may be included in the telephone 22 and/or the microphone 24.

In various implementations, the threat identification module 26 may be omitted or incorporated into the threat detection module 18, and the threat detection module 18 may transmit a signal directly to the central command center 12 when a threat is identified. For example, if a gunshot is detected or a weapon is detected, the threat detection module 18 may output a signal directly to the central command center 12 indicating that the gunshot or weapon is detected, and possibly the location of the gunshot or weapon. In another example, if the silent alarm 20 is triggered, the silent alarm 20 may output a signal directly to the central command center 12 indicating that the silent alarm 20 has been triggered, and possibly the location of the silent alarm 20.

The central command center 12 includes a plurality of user interface devices 28 that enable a chief 30 and a plurality of operators 32 to communicate with the drone groups 16 and the threat identification module 26. Each user interface device 28 may be positioned near the chief 30 or one of the operators 32. Each user interface device 28 may include a touchscreen or another electronic display (e.g., a monitor), a keyboard, a processor, memory, a microphone, and/or a vibrator. The vibrator may be mounted within a desk or a seat for the chief 30 or one of the operators 32.

The user interface device 28 near the chief 30 receives the threat identification signal when the threat identification module 26 identifies a threat in the facility 14. In response, that user interface device 28 generates an audible message (e.g., tone, verbal words), a visual message (e.g., light, text), and/or a tactile message (e.g., vibration) indicating that a threat has been identified in the facility 14. The message(s) may also indicate the location of the threat in the facility 14 and, if the threat is a gunshot, the direction of the gunshot and/or the number of gunshots detected. In addition, if the threat is a weapon, the message(s) may also indicate the type of weapon detected. In various implementations, the user interface devices 28 near the operators 32 may also receive the threat identification signal and may generate the audible message, the visual message, and/or the tactile message in response thereto.

When the chief 30 observes the message(s) indicating that a threat has been identified in the facility 14, the chief 30 communicates with the operators 32 using the user interface device 28 to coordinate operation of the drone groups 16. Each operator 32 controls one of the drone groups 16 using one of the user interface devices 28. In addition, the chief 30 communicates with local authorities (e.g., police department, fire department, emergency medical service) to inform them that the threat has been identified in the facility 14, and to relay any information gathered by the drone groups 16.

Each operator 32 controls one of the drone groups 16 by manipulating one the user interface devices 28 to output a control signal to that drone group 16. The drone control signal may indicate a target location, and the drone groups 16 may automatically move toward that target location. The operators 32 may set the target location to the location of the threat or to a location that is near the location of the threat. Alternatively, the drone control signal may indicate the desired speed and/or travel direction of the drone groups 16, and the drone groups 16 may adjust operation of their actuators (e.g., propellers, rudders) to achieve the desired speed and/or travel direction. The operators 32 may control the speed and/or travel direction of the drone groups 16 based on the locations of the drone groups 16 and/or video recorded by the drone groups 16.

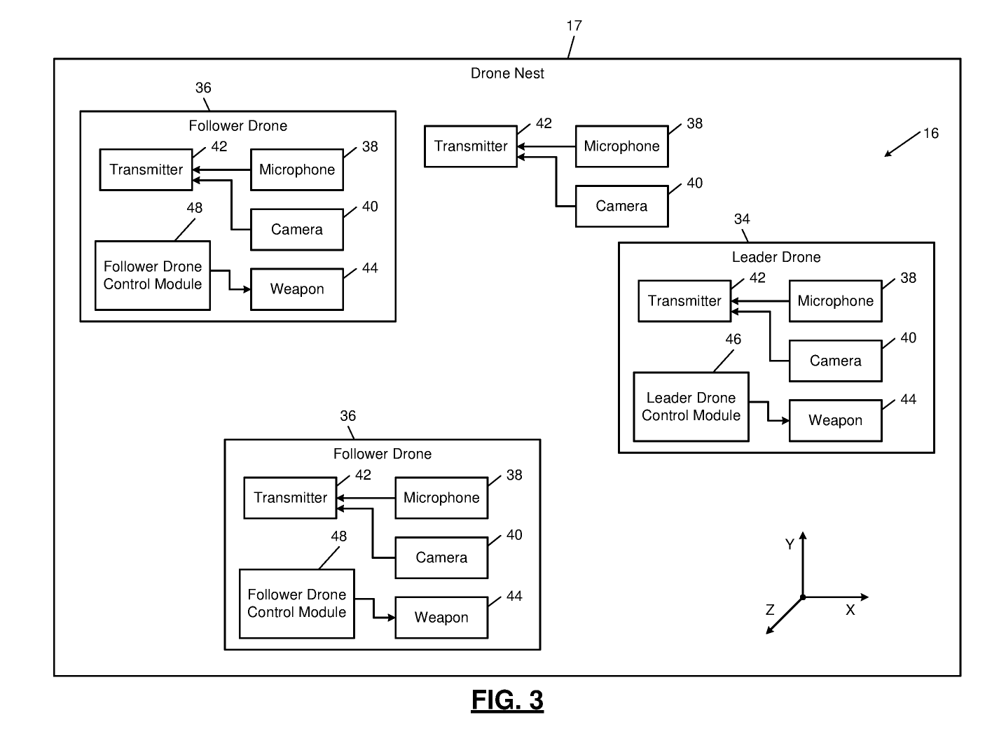

Referring now to FIG. 3, an example implementation of any one of the drone groups 16 includes a leader drone 34 and one or more follower drones 36 housed within one of the drone nests 17. The leader drone 34 receives the drone control signal from one of the user interface devices 28 and adjusts its speed and/or travel direction based on the drone control signal. The follower drones 36 adjusts their respective speeds and/or travel directions to follow the leader drone 34 and a predetermined distance and/or and a predetermined formation. In addition, if the leader drone 34 is damaged or malfunctions, one of the follower drones 36 may take the place of the leader drone 34.

Each of the leader drone 34, the follower drones 36, and the drone nest 17 may include a microphone 38, a camera 40, a transmitter 42, and/or a weapon 44. Each microphone 38 records audio in the facility 14 that is within a detectable range thereof. Each camera 40 records video of an area in the facility 14 that is within the field of view thereof. Each camera 40 may have a field of view of 360 degrees. Each transmitter 42 transmits the recorded audio and video to the central command center 12. The transmitter 42 may transmit the recorded audio and video to the user interface device(s) 28 of the chief 30 and/or one or more of the operators 32. For example, the transmitter 42 may transmit the recorded audio and video to the user interface device 28 of the operator 32 that is controlling the drone group 16 in which the transmitter 42 is included.

Each weapon 44 may include an electroshock weapon, a gas or pepper spray, a firearm, and/or a tranquilizer. The leader and follower drone control modules 46 and 48 output a signal that causes the weapons 44 to discharge. The leader and follower drone control modules 46 and 48 may discharge the weapons 44 based on signals received from the user interface devices 28. For example, each operator 32 may control one of the user interface devices 28 to output a weapon discharge signal, and one of the leader or follower drone control modules 46 or 48 may discharge one of the weapons 44 in response to the weapon discharge signal. The weapon discharge signal may indicate that a weapon discharge is desired and which one of the weapons 44 is to be discharged. Alternatively, the leader and follower drone control modules 46 and 48 may discharge the weapons 44 automatically (i.e., independent of input from the user interface devices 28) when the threat is within the field of view of the camera 40 and/or the drone group 16 is within a predetermined distance of the threat.

The leader drone 34 may further include a global positioning system (GPS) module that determines the location of the leader drone 34. When the drone control signal indicates a target location, the leader drone control module 46 may adjust the speed and/or travel direction of the leader drone 34 automatically (i.e., independent of input from the user interface devices 28) based on the target location. For example, the leader drone control module 46 may automatically adjust the actuators of the leader drone 34 to minimize a difference between the current location of the leader drone 34 and the target location. In addition, the leader drone control module 46 may discharge the weapon 44 based on the location of the leader drone 34 as described above.

In various implementations, the leader drone control module 46 may control the actuators of the leader drone 34 to deploy the leader drone 34 and adjust the speed and/or travel direction of the leader drone 34 independent of the central command center 12. In these implementations, the threat identification module 26 may output the threat identification signal to the leader drone control module 46 of each drone group 16, and the leader drone control module 46 may set the target location of the leader drone 34 to the location of the threat or to a location that is within a predetermined distance of the threat. The leader drone control module 46 may then automatically adjust the speed and/or travel direction of the leader drone 34 based on the target location.

Each follower drone 36 may also include a GPS module that determines the location of the respective follower drone 36. The follower drone control module 48 may automatically adjust the actuators of the respective follower drone 36 based on a difference between the current location of that follower drone 36 and the current location of the leader drone 34. For example, the follower drone control module 48 may adjust the actuators of the respective follower drone 36 to maintain a predetermined distance between that follower drone 36 and the leader drone 34 in an X direction (e.g., a forward-reverse direction) and a Y direction (e.g., a side-to-side direction). The follower drone control module 48 may receive the current location of the leader drone 34 from the transmitter 42 in the leader drone 34. Although the leader and follower drone control modules 46 and 48 are described as different modules, the follower drone control module 48 may perform all of the functions of the leader drone control module 46 if the respective follower drone 36 takes the place of the leader drone 34.

Each of the leader drone 34 and the follower drones 36 may also include an altimeter that measures the height of the respective leader or follower drone 34 or 36. The leader and follower drone control modules 46 and 48 may automatically adjust the actuators of the leader and follower drones 34 and 36 to minimize a difference between a current height of the leader or follower drone 34 or 36 and a target height. The target height may be predetermined. Alternatively, the leader drone control module 46 may receive the target height of the leader drone 34 from one of the user interface devices 28 via the drone control signal. The follower drone control modules 48 may adjust the actuators of the follower drones 36 to maintain the follower drones 36 at the same height as the leader drone 34 or at a different height. For example, each follower drone control module 48 may adjust the actuators of the respective follower drone 36 to maintain a predetermined distance between that follower drone 36 and the leader drone 34 in a Z direction (e.g. a vertical direction).

The threat identification module 26 (FIG. 2) may identify a threat in the facility 14 based on the audio recorded by the microphone(s) 38 and/or the video recorded by the camera(s) 40 in one or more (e.g., all) of the drone nest 17, the leader drone 34, the follower drones 36. For example, the threat identification module 26 may recognize words in the audio signals from the microphones 38 and identify a threat in the facility 14 when a recognized word or phrase matches a predetermined word or phrase. In various implementations, the audio recorded by the microphone 38 may be used instead of the audio recorded by the microphone 24 (FIG. 2) to identify threats in the facility 14. In these implementations, the microphone 24 may be omitted.

The audio recorded by the microphone 38 in the drone nest 17 and/or the video recorded by the camera 40 in the drone nest 17 may be used to identify and/or monitor a threat before the leader and follower drones 34 and 36 are deployed from the nest 17. In one example, the drone nest 17 is activated (e.g., switched on, woken up) when a threat is identified in the facility 14, and the drone nest 17 is not activated before the threat is identified to protect the privacy of individuals in the facility 14. When the nest 17 wakes up, the central command center 12 may use the audio and video recorded by the microphone 38 and camera 40 in the drone nest 17 to monitor the threat.

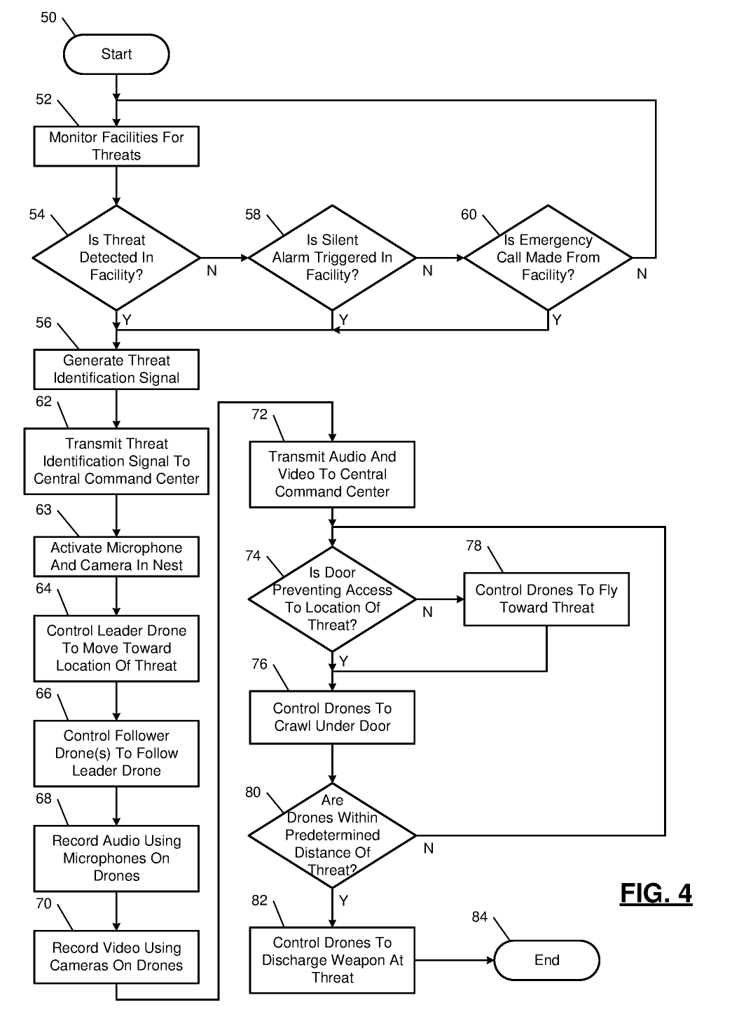

Referring now to FIG. 4, a method for mitigating a threat in one of the facilities 14 begins at 50. The method is described in the context of the modules of FIG. 2. However, the particular modules that perform the steps of the method may be different than the modules mentioned below, or the method may be implemented apart from the modules of FIG. 2. In addition, while the method is described with reference to the leader and follower drones 34 and 36 of FIG. 3, the method may be used to control other drones or drone formations in the same manner.

At 52, the threat detection modules 18 monitor the facilities 14 for threats (e.g., gunfire, a weapon). At 54, the threat identification module 26 determines whether a threat is detected in one of the facilities 14 based on input from the threat detection modules 18. If a threat is detected in one of the facilities 14, the method continues at 56. Otherwise, the method continues at 58.

At 58, the threat identification module 26 determines whether the silent alarm 20 is triggered in one of the facilities 14. If the silent alarm 20 is triggered, the method continues at 56. Otherwise, the method continues at 60. At 60, the threat identification module 26 determines whether an emergency call is made using the telephone 22 in one of the facilities 14. If an emergency call is made from one of the facilities 14, the method continues at 56. Otherwise, the method continues at 52.

At 56, the threat identification module 26 generates the threat identification signal. At 62, the threat identification module 26 transmits the threat identification signal to the central command center 12. At 63, the microphone 38 and/or camera 40 mounted in each drone nest 17 activates in response to the threat identification signal, and the transmitter 42 in each done nest 17 transmits the recorded audio and video to the central command center 12.

At 64, the leader drone control module 46 controls the leader drone 34 of each drone group 16 to move toward the location of the threat. The leader drone control module 46 may control the leader drone 34 of each drone group 16 in response to a command from the central command center 12 or independent of the central command center 12. In addition, the leader done control module 46 (or the central command center 12) may not control the leader done 34 to move toward the threat when, for example, the drone nest 17 is directly above the threat and/or within a predetermined distance of the threat. At 66, the follower drone control modules 48 controls the follower drones 36 to follow the leader drone 34 in their respective drone group 16.

At 68, the leader and follower drones 34 and 36 record audio in the facility 14 using their respective microphones 38. At 70, the leader and follower drones 34 and 36 record video in the facility 14 using their respective cameras 40. At 72, the leader and follower drones 34 and 36 transmit the recorded audio and the recorded video to the central command center 12 using their respective transmitters 42.

At 74, the leader drone control module 46, one of the follower drone control modules 48, or one of the operators 32 determines whether a door is preventing access to the location of the threat. If a door is preventing access to the location of the threat, the method continues at 76. Otherwise the method continues at 78.

The leader drone control module 46, the follower drone control modules 48, and the operators 32 may determine that a door is preventing access to the location of the threat when (i) the door is between the current location of the respective drone group 16 and the location of the threat and (ii) the door is closed. The leader drone control module 46, the follower drone control modules 48, and the operators 32 may determine whether the door is open or closed based on the video recorded by the cameras 40. For example, the leader and follower drone control modules 46 and 48 may detect edges of an object in the images recorded by the cameras 40, determine the size and shape of the object based on the edges, and determine whether the object is a door or a door opening based on the size and shape of the object. The leader and follower drone control modules 46 and 48 may then determine whether a door is obstructing a door opening based on the spatial relationship between the door and door opening.

At 78, the leader and follower drone control modules 46 and 48 control the leader and follower drones 34 and 36, respectively, to crawl under the door. The leader and follower drone control modules 46 and 48 may automatically control the leader and follower drones 34 and 36 to crawl under the door when the door is preventing access to the threat. Alternatively, one of the operators 32 may instruct the leader and follower drone control modules 46 and 48 to control the leader and follower drones 34 and 36 to crawl under the door via the drone control signal. At 78, the leader and follower drone control modules 46 and 48 control the leader and follower drones 34 and 36, respectively, to fly toward threat.

At 80, the leader and follower drone control module 46 and 48 determine whether the leader and follower drones 34 and 36 are within a predetermined distance of the threat. If the leader and follower drones 34 and 36 are within the predetermined distance of the threat, the method continues at 82. Otherwise, the method continues at 74. At 82, the operators 32 instruct the leader and follower drone control modules 46 and 48 to discharge the weapons 44 at the threat. Alternatively, the leader and follower drone control modules 46 and 48 may discharge the weapons 44 at the threat automatically (i.e., independent of input from the central command center 12). For example, the leader and follower drone control modules 46 and 48 may identify the object in the image captured by the cameras 40 is a person using edge detection. In addition, the leader and follower drone control modules 46 and 48 may determine that person is holding and/or discharging a weapon when the location of the person matches the location of the threat. In turn, the leader and follower drone control modules 46 and 48 may discharge the weapons 44 at that person.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A system for mitigating a threat in a facility, the system comprising:
a threat identification module configured to:
generate a threat identification signal indicating that the threat has been identified in the facility; and
transmit the threat identification signal to a central command center; and
at least one group of drones positioned within the facility and configured to move toward the threat in response to at least one of the threat identification signal and a command from the central command center.

2. The system of claim 1 further comprising a gunshot detection module configured to detect a gunshot in the facility, wherein the threat identification module is configured to generate the threat identification signal when the gunshot is detected.

3. The system of claim 1, further comprising a silent alarm operable to output a signal indicative of a trespasser, wherein the threat identification module is configured to generate the threat identification signal when in receipt of the signal from the silent alarm.

4. The system of claim 1 wherein the threat identification module is configured to generate the threat identification signal when in receipt of a signal that an emergency call is made from the facility.

5. The system of claim 1 further comprising a microphone located in the facility, wherein the threat identification module is configured to generate the threat identification signal when the microphone detects a predetermined voice command.

6. The system of claim 1 further comprising a weapon detection module configured to detect a weapon in the facility, wherein the threat identification module is configured to generate the threat identification signal when the weapon is detected.

7. The system of claim 1 wherein:
the threat identification signal further indicates a location of the threat; and
the at least one group of drones is configured to fly toward the threat in response to the threat identification signal.

8. The system of claim 1 wherein each of the at least one group of drones includes at least three drones.

9. The system of claim 1 wherein:
each of the at least one group of drones includes a leader drone and a follower drone;
the leader drone includes a leader drone control module configured to control the leader drone to move toward the threat in response to at least one of the threat identification signal and the command from the central command center; and
the follower drone includes a follower drone control module configured to control the follower drone to follow the leader drone.

10. The system of claim 1 wherein:
the at least one group of drones includes a plurality of drone groups;
the system further comprises a nest for each group of drones; and
the number and positions of the nests are selected to ensure that at least one of the drones groups arrives at the threat within a desired response time.

11. The system of claim 1 wherein at least one of the drones includes:
a microphone configured to record audio;
a camera configured to record video; and
a transmitter configured to transmit the recorded audio and the recorded video to the central command center.

12. The system of claim 1 wherein at least one of the drones includes:
a weapon; and
a drone control module configured to discharge the weapon at the threat.

13. The system of claim 1 wherein at least one of the drones is configured to crawl under a door when the threat is located in a room of the facility that is accessible by the door and the door is closed.

14. A method for identifying and mitigating a threat in a facility, the method comprising:
generating a threat identification signal indicating that the threat has been identified in the facility;
transmitting the threat identification signal to a central command center;
positioning at least one group of drones in the facility; and
controlling the at least one group of drones to move within the facility toward the threat in response to the threat identification signal.

15. The method of claim 14 further comprising:
detecting a gunshot in the facility; and
generating the threat identification signal when the gunshot is detected.

16. The method of claim 14 further comprising a silent alarm operable to output a signal indicative of a trespasser, generating the threat identification signal when in receipt of the signal from the silent alarm.

17. The method of claim 14 further comprising generating the threat identification signal when in receipt of a signal that an emergency call is made from the facility.

18. The method of claim 14 further comprising generating the threat identification signal when a microphone located in the facility detects a predetermined voice command.

19. The method of claim 14 further comprising:
detecting a weapon in the facility; and
generating the threat identification signal when the weapon is detected.

20. The method of claim 14 wherein the threat identification signal further indicates a location of the threat, the method further comprising controlling the at least one group of drones to fly toward the threat in response to the threat identification signal.

21. The method of claim 14 further comprising transmitting a command from the central command center to the facility in response to the threat identification signal, wherein the at least one group of drones is configured to fly toward the threat in response to the command from the central command center.

22. The method of claim 14 wherein each of the at least one group of drones includes a leader drone and a follower drone, the method further comprising:
controlling the leader drone to move toward the threat in response to the threat identification signal; and
controlling the follower drone to follow the leader drone.

23. The method of claim 14 wherein the at least one group of drones includes a plurality of drone groups that are each stationed within a nest, the method further comprising selecting the number and positions of the nests to ensure that at least one of the drones groups arrives at the threat within a desired response time.

24. The method of claim 14 wherein at least one of the drones includes a microphone configured to record audio and a camera configured to record video, the method further comprising transmitting the recorded audio and the recorded video to the central command center.

25. The method of claim 14 wherein at least one of the drones includes a weapon, the method further comprising discharging the weapon at the threat.

26. The method of claim 14 further comprising controlling at least one of the drones to crawl under a door when the threat is located in a room of the facility that is accessible by the door and the door is closed.
